(19) United States
(12) Patent Application Publication
(10) Pub. No.: US 2026/0054189 A1
(43) Pub. Date: Feb. 26, 2026

(54) TOY CAR TIRE AND TOY CAR USING SAME

(71) Applicant: Shenzhen Dawn Model Technology Co.,Ltd., Longhua (CN)

(72) Inventor: Changfei Sun, Wuhan City (CN)

(21) Appl. No.: 18/828,086

(22) Filed: Sep. 9, 2024

(30) Foreign Application Priority Data
Aug. 20, 2024 (CN) 202422025920.0

(51) Int. Cl. A63H 17/26; B60C 7/10

(52) U.S. Cl. CPC A63H 17/262; B60C 7/101

(57) ABSTRACT

A toy car tire includes a tire main body and a filler core. The tire main body includes an inner cavity and a first opening. The inner cavity is surrounded and formed by a side wall of the tire main body, and the first opening is in communication with the inner cavity. The filler core is inserted into the inner cavity through the first opening. The filler core is configured for filling the inner cavity. Therefore, the filler core is capable of filling the inner cavity of the tire main body to support the tire main body, making the tire main body fuller and less prone to deformation. Moreover, compared with an inflatable tire, since the inner cavity is filled with the filler core, the toy car tire is not afraid of being punctured. Even if punctured, the tire main body of the tire is still full.

### CROSS-REFERENCE TO RELATED APPLICATIONS

The application claims priority of Chinese patent application CN2024220259200, filed on Aug. 20, 2024, which is incorporated herein by reference in its entireties.

### TECHNICAL FIELD

The present disclosure relates to the field of toy cars, particularly to a toy car tire and a toy car using the toy car tire.

### BACKGROUND ART

The main function of toy cars is for children's play, and the toy cars are usually scaled down according to the basic structure and appearance of a car in a certain proportion. These toys not only bring joy to children, but also have various practical and educational significance.

Toy cars have rich colors and diverse designs, which can attract children's attention, stimulate their imagination and creativity. For example, children's track toy cars allow children to freely unleash their imagination on specific tracks and design their own unique gameplay.

Toy cars such as freewheels vehicles and children's wiggle ride-on cars can help children exercise balance, improve body coordination, and promote the development of motor skills. These toys are particularly suitable as transitional tools for young children learning to ride bicycles or use scooters.

Toy cars also play an important role in children's intellectual development. By operating toy cars, children can train their visual abilities, achieve hand-eye coordination, cultivate the concept of numbers, perform basic addition and subtraction operations, recognize colors, exercise wrist flexibility, and develop the ability to work with both hands alternately.

Toy cars can also enhance children's social skills. Children can play together and share the fun of toy cars, which helps them learn to cooperate and communicate with others.

However, most of the tires of toy cars currently on the market are inflatable tires, which are easily punctured when encountering uneven roads or nails, resulting in tire damage and inability to function properly, with a short service life.

Therefore, there is an urgent need on the market to provide a toy car tire and a toy car using the toy car tire that are not easily punctured and have a long service life, so as to improve the user experience.

### SUMMARY

In order to overcome the shortcomings of the prior art, a toy car tire is provided. The toy car tire includes a tire main body and a filler core. The tire main body includes an inner cavity and a first opening. The inner cavity is surrounded and formed by a side wall of the tire main body, and the first opening is in communication with the inner cavity. The filler core is inserted into the inner cavity through the first opening. The filler core is configured for filling the inner cavity.

As an improvement of the present disclosure, the tire main body is provided with drainage and ventilation holes. The drainage and ventilation holes are in communication with the inner cavity.

As an improvement of the present disclosure, the tire main body is an elastic tire main body, and the filler core is an elastic filler core.

As an improvement of the present disclosure, the filler core is a sponge filler core.

As an improvement of the present disclosure, the filler core is a silicone filler core.

As an improvement of the present disclosure, the filler core is a honeycomb shaped filler core.

As an improvement of the present disclosure, the tire main body is equipped with a first front side wall, a first rear side wall, and a first circumferential side wall connected to the first front side wall and the first rear side wall. The filler core is equipped with a second front side wall, a second rear side wall, and a second circumferential side wall connected to the second front side wall and the second rear side wall. The second circumferential side wall is arranged towards the first circumferential side wall, the second front side wall is arranged towards the first front side wall, and the second rear side wall is arranged towards the first rear side wall.

As an improvement of the present disclosure, the tire main body is equipped with a plurality of drainage and ventilation holes. The plurality of drainage and ventilation holes are arranged around the first circumferential side wall.

As an improvement of the present disclosure, a plurality of hollow holes are defined in the filler core. The plurality of hollow holes are spaced apart from each other.

As an improvement of the present disclosure, the hollow hole penetrates from the second front side wall to the second rear side wall. The plurality of hollow holes are arranged transversely and longitudinally along the second front side wall and the second rear side wall.

As an improvement of the present disclosure, the filler core includes a first hollow area and a second hollow area. The first hollow area and the second hollow area are arranged in sequence from a center of the filler core to an edge of the filler core. The plurality of hollow holes include a plurality of first hollow hole units and second hollow hole units. The plurality of first hollow hole units are arranged along a circumference of the first hollow area, and the plurality of second hollow hole units are arranged along a circumference of the second hollow area. A shape of the first hollow hole unit is different from a shape of the second hollow hole unit.

As an improvement of the present disclosure, the filler core includes a third hollow area. The third hollow area is positioned between the first hollow area and the second hollow area. The plurality of hollow holes also include a plurality of third hollow hole units. The plurality of third hollow hole units are arranged along a circumference of the third hollow area. A shape of the third hollow hole unit is different from the shape of the first hollow hole unit and the shape of the second hollow hole unit.

As an improvement of the present disclosure, the plurality of hollow holes also include a plurality of fourth hollow hole units. The plurality of fourth hollow hole units are arranged along the circumference of the first hollow area. The fourth hollow hole unit and the first hollow hole unit are spaced apart from each other. A shape of the fourth hollow hole unit is different from the shape of the first hollow hole unit.

As an improvement of the present disclosure, the plurality of hollow holes also include a plurality of fifth hollow hole units. The plurality of fifth hollow hole units are arranged along the circumference of the second hollow area. The fifth hollow hole unit and the second hollow hole unit are spaced apart from each other. A shape of the fifth hollow hole unit is different from the shape of the second hollow hole unit.

As an improvement of the present disclosure, the tire main body is provided with a plurality of protruding anti-slip patterns. The plurality of protruding anti-slip patterns are arranged around the tire main body. The anti-slip patterns include a plurality of protruding first anti-slip patterns, a plurality of protruding second anti-slip patterns, a plurality of protruding third anti-slip patterns, and a plurality of protruding fourth anti-slip patterns. A shape of the first anti-slip pattern is identical with a shape of the second anti-slip pattern, a shape of the third anti-slip pattern is identical with a shape of the fourth anti-slip pattern, and the shape of the first anti-slip pattern is different from the shape of the third anti-slip pattern. The first anti-slip pattern and the second anti-slip pattern are respectively positioned at a front edge and a rear edge of the first circumferential side wall. The third anti-slip pattern and the fourth anti-slip pattern are positioned between the first anti-slip pattern and the second anti-slip pattern. Moreover, the third anti-slip pattern and the fourth anti-slip pattern are arranged side by side in a middle portion of the first circumferential side wall. The plurality of first anti-slip patterns, the plurality of second anti-slip patterns, the plurality of third anti-slip patterns, and the plurality of fourth anti-slip patterns are arranged around the first circumferential side wall.

As an improvement of the present disclosure, the first anti-slip pattern includes a first anti-slip pattern unit and a second anti-slip pattern unit. The second anti-slip pattern includes a third anti-slip pattern unit and a fourth anti-slip pattern unit. A shape of the first anti-slip pattern unit is different from a shape of the second anti-slip pattern unit. A shape of the third anti-slip pattern unit is different from a shape of the fourth anti-slip pattern unit. The shape of the first anti-slip pattern unit is identical with the shape of the third anti-slip pattern unit. The shape of the second anti-slip pattern unit is identical with the shape of the fourth anti-slip pattern unit. The first anti-slip pattern unit and the second anti-slip pattern unit are spaced apart from each other. The third anti-slip pattern unit and the four anti-slip pattern unit are spaced apart from each other.

As an improvement of the present disclosure, the third anti-slip pattern includes a fifth anti-slip pattern unit, a sixth anti-slip pattern unit, and a seventh anti-slip pattern unit. The fourth anti-slip pattern includes an eighth anti-slip pattern unit, a ninth anti-slip pattern unit, and a tenth anti-slip pattern unit. Shapes of the fifth anti-slip pattern unit, the sixth anti-slip pattern unit, and the seventh anti-slip pattern unit are different from each other. Shapes of the eighth anti-slip pattern unit, the ninth anti-slip pattern unit, and the tenth anti-slip pattern unit are different from each other. The shape of the fifth anti-slip pattern unit is identical with the shape of the eighth anti-slip pattern unit. The shape of the sixth anti-slip pattern unit is identical with the shape of the ninth anti-slip pattern unit. The shape of the seventh anti-slip pattern unit is identical with the shape of the tenth anti-slip pattern unit. The fifth anti-slip pattern unit, the sixth anti-slip pattern unit, and the seventh anti-slip pattern unit are spaced apart from each other. Moreover, the sixth anti-slip pattern unit is positioned between the fifth anti-slip pattern unit and the seventh anti-slip pattern unit. The eighth anti-slip pattern unit, the ninth anti-slip pattern unit, and the tenth anti-slip pattern unit are spaced apart from each other. Moreover, the ninth anti-slip pattern unit is positioned between the eighth anti-slip pattern unit and the tenth anti-slip pattern unit. The fifth anti-slip pattern unit is connected to the first anti-slip pattern unit through a first connecting rib. The eighth anti-slip pattern unit is connected to the third anti-slip pattern unit through a second connecting rib. The seventh anti-slip pattern unit is connected to the second anti-slip pattern unit through a third connecting rib. The tenth anti-slip pattern unit is connected to the fourth anti-slip pattern unit through a fourth connecting rib.

As an improvement of the present disclosure, the toy car tire further includes a wheel hub, and the tire main body is also provided with a sleeve opening. The wheel hub is inserted into the sleeve opening. The wheel hub includes a protruding first clamping wall, a protruding second clamping wall, and a first connecting wall connected to the first clamping wall and the second clamping wall. The first connecting wall is inserted into the sleeve opening, and the first clamping wall and the second clamping wall clamp the tire main body.

As an improvement of the present disclosure, the wheel hub further includes a connecting part. The connecting part is connected to the second clamping wall. The connecting part is provided with a connecting hole. The connecting hole is configured for connecting with a wheel axle of a toy car. The first clamping wall is detachably connected to one end of the first connecting wall, and the second clamping wall is detachably connected to an opposite end of the first connecting wall. Alternatively, the first clamping wall is detachably connected to one end of the first connecting wall, and the second clamping wall is integrally formed with an opposite end of the first connecting wall.

As an improvement of the present disclosure, the connecting part is connected to the second clamping wall through a plurality of second connecting walls. First hollow parts are provided between the plurality of second connecting walls, and second hollow parts are provided on the second connecting walls. A shape of the second hollow part is different from a shape of the first hollow part.

As an improvement of the present disclosure, the toy car tire further includes an installation cap. The installation cap is arranged towards the connecting hole, and the installation cap is detachably connected to the wheel hub.

As an improvement of the present disclosure, the shape of the fourth hollow hole unit is complementary to the shape of the first hollow hole unit. The shape of the fifth hollow hole unit is complementary to the shape of the second hollow hole unit.

As an improvement of the present disclosure, the third hollow hole unit is elliptical in shape. The first hollow hole unit is in a tower shape. The second hollow hole unit is trapezoidal in shape, and the fifth hollow hole unit is triangular in shape.

As an improvement of the present disclosure, the connecting hole is hexagonal in shape.

As an improvement of the present disclosure, the shape of the first hollow part is triangular, and the shape of the second hollow part is elliptical.

As an improvement of the present disclosure, the installation cap is detachably connected to the wheel hub through screws.

As an improvement of the present disclosure, the first clamping wall and the first connecting wall are detachably connected by screws.

A toy car is further provided, including the aforementioned toy car tire.

Beneficial effects of the present disclosure are as follows. The toy car tire includes the tire main body and the filler core. The tire main body includes the inner cavity and the first opening. The inner cavity is surrounded and formed by the side wall of the tire main body, and the first opening is in communication with the inner cavity. The filler core is inserted into the inner cavity through the first opening. The filler core is configured for filling the inner cavity. Therefore, the filler core is capable of filling the inner cavity of the tire main body to support the tire main body, making the tire main body fuller and less prone to deformation. Moreover, compared with an inflatable tire, since the inner cavity is filled with the filler core, the toy car tire is not afraid of being punctured. Even if punctured, the tire main body of the tire is still full and does not affect the travel of the toy car.

### BRIEF DESCRIPTION OF THE DRAWINGS

Implementations of the present disclosure will now be described, by way of embodiment, with reference to the attached figures. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is a schematic diagram of an overall structure of the present disclosure.

FIG. 2 is an enlarged view of area A in FIG. 1.

FIG. 3 is an exploded view of the present disclosure.

FIG. 4 is an enlarged view of area B in FIG. 3.

FIG. 5 is a sectional view cut along a filler core and a tire main body.

FIG. 6 is an enlarged view of area C in FIG. 5.

FIG. 7 is a sectional view cut along a filler core, a tire main body, and a wheel hub.

FIG. 8 is an enlarged view of area D in FIG. 7.

### DETAILED DESCRIPTION OF THE EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. In addition, the terms “first” and “second” are used for descriptive purposes only and cannot be understood as indicating or implying relative importance or implying the number of indicated technical features. Thus, the features defined as “first” and “second” may explicitly or implicitly include one or more of the features. In the description of embodiments of the application, “a plurality of”means two or more, unless otherwise specifically defined.

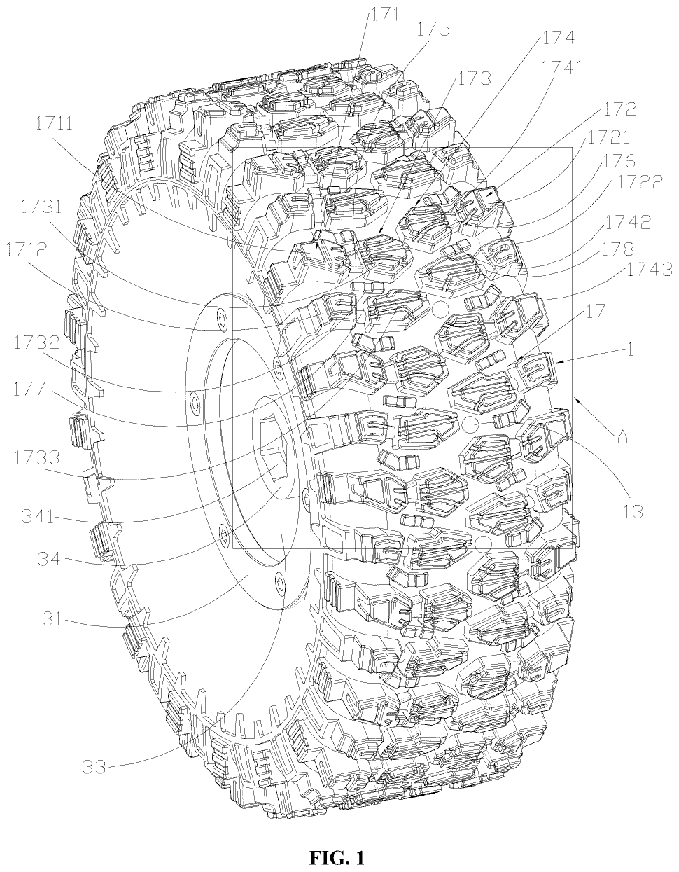

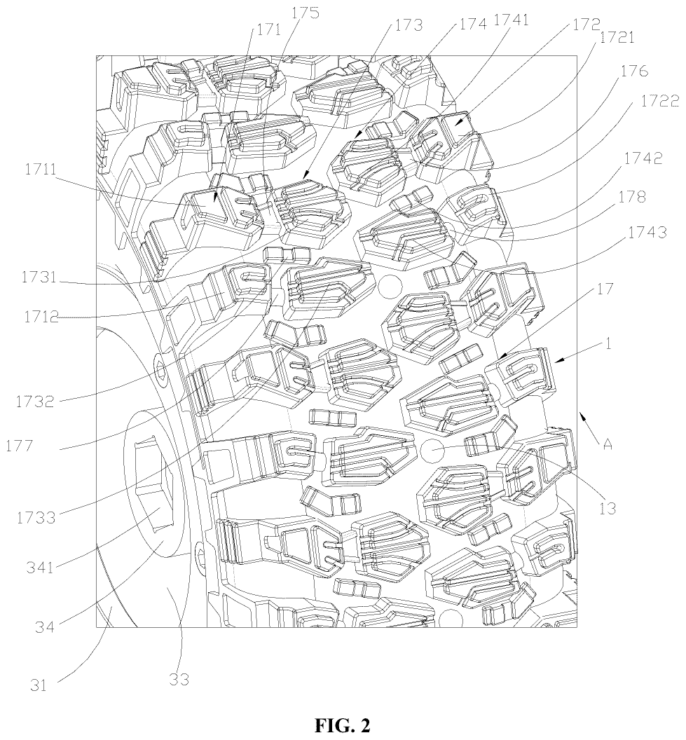

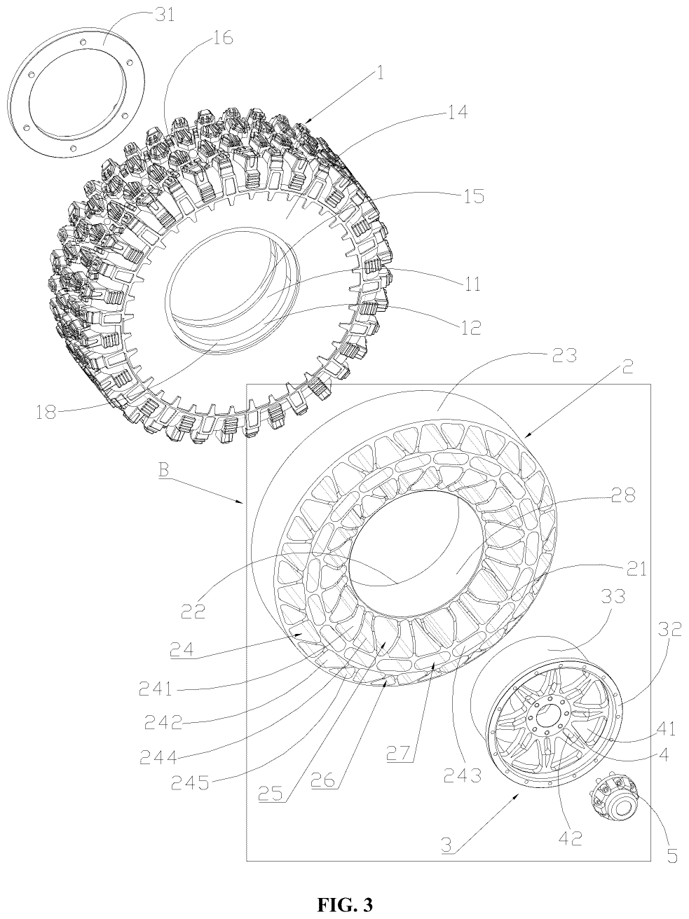

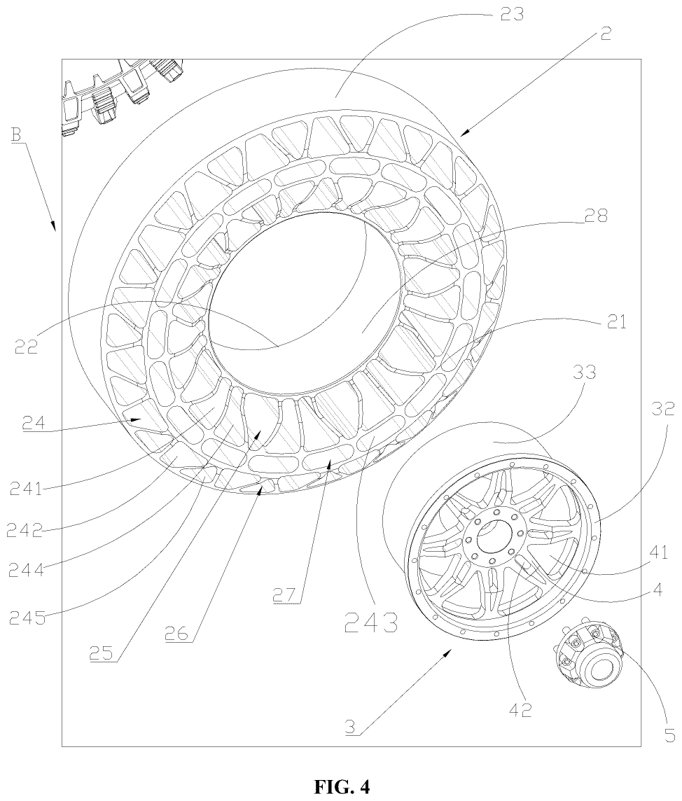

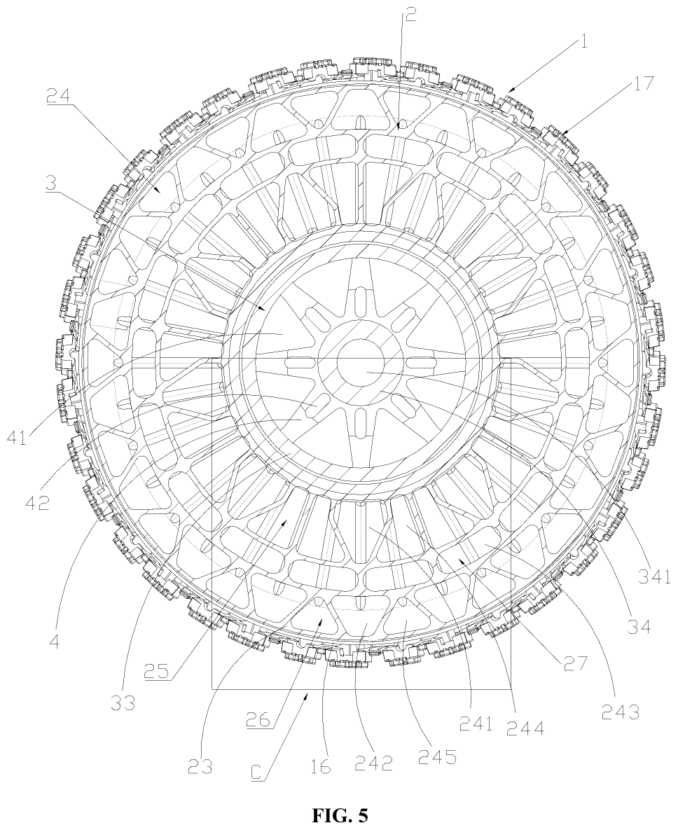

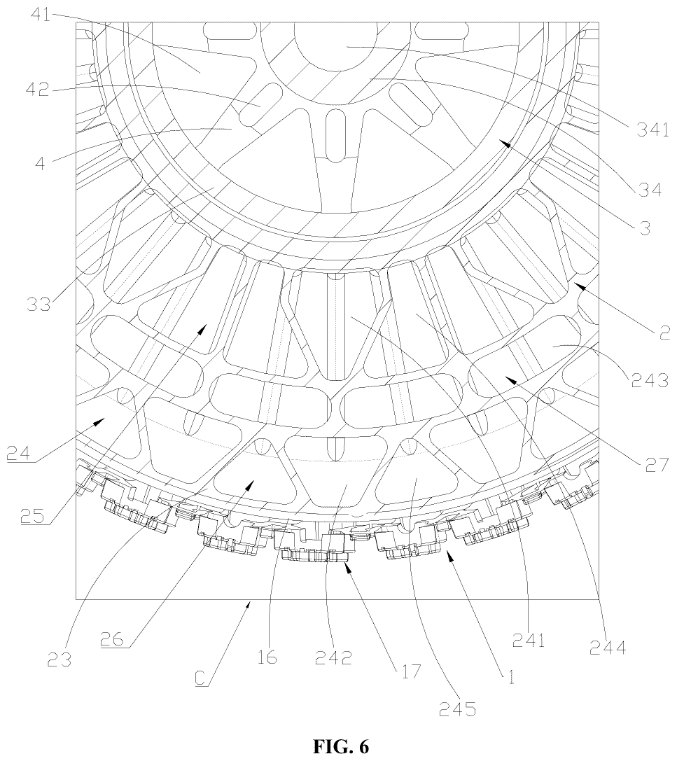

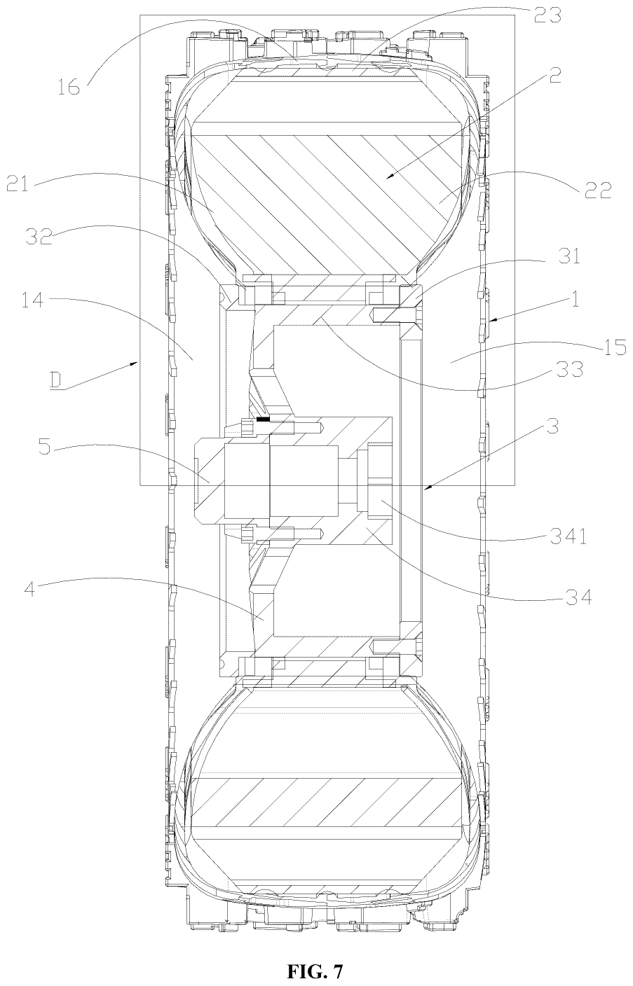

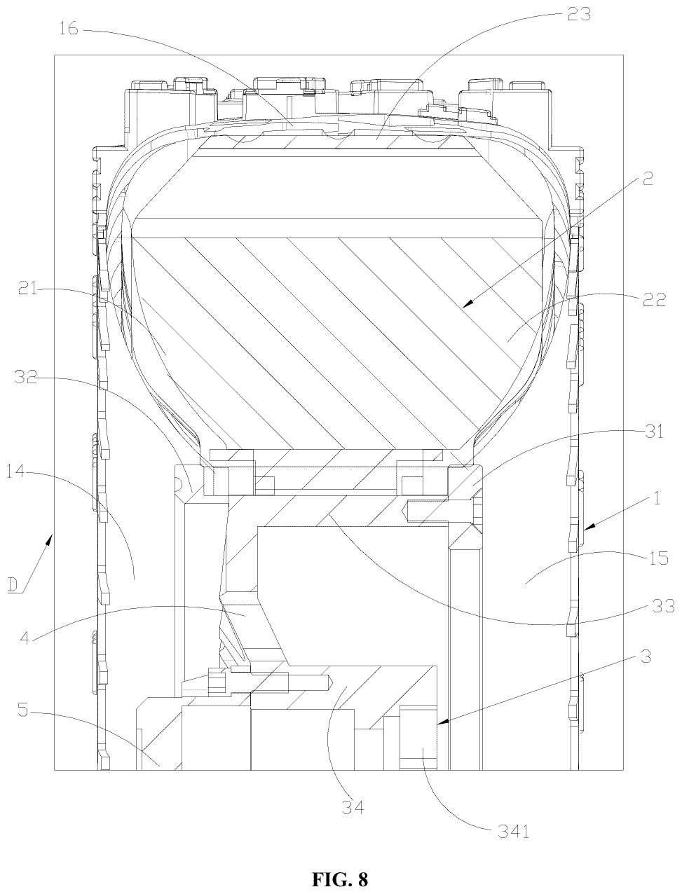

Referring to FIGS. 1-8, a toy car tire includes a tire main body 1 and a filler core 2.

The tire main body 1 includes an inner cavity 11 and a first opening 12. The inner cavity 11 is surrounded and formed by a side wall of the tire main body 1, and the first opening 12 is in communication with the inner cavity 11.

The filler core 2 is inserted into the inner cavity 11 through the first opening 12. The filler core 2 is configured for filling the inner cavity 11.

Through the above structure, the toy car tire includes the tire main body 1 and the filler core 2. The tire main body 1 includes the inner cavity 11 and the first opening 12. The inner cavity 11 is surrounded and formed by the side wall of the tire main body 1, and the first opening 12 is in communication with the inner cavity 11. The filler core 2 is inserted into the inner cavity 11 through the first opening 12. The filler core 2 is configured for filling the inner cavity 11. Therefore, the filler core 2 is capable of filling the inner cavity 11 of the tire main body 1 to support the tire main body 1, making the tire main body 1 fuller and less prone to deformation. Moreover, compared with an inflatable tire, since the inner cavity 11 is filled with the filler core 2, the toy car tire is not afraid of being punctured. Even if punctured, the tire main body 1 of the tire is still full and does not affect the travel of a toy car.

In this embodiment, the tire main body 1 is provided with drainage and ventilation holes 13. The drainage and ventilation holes 13 are in communication with the inner cavity 11. Through the above structure, since the tire main body 1 is provided with the drainage and ventilation holes 13, and the drainage and ventilation holes 13 are in communication with the inner cavity 11, the tire main body 1 can undergo slight deformation when encountering an uneven road surface and being squeezed by the road surface during the travel of the toy car, allowing the toy car to smoothly cross the uneven road surface. Moreover, when the toy car crosses the uneven road surface, the presence of the drainage and ventilation holes 13 can facilitate the tire main body 1 to quickly recover to an initial shape, so that the toy car can travel more smoothly on the road surface. Furthermore, when the toy car is driven on rainy days or in water, the water that seeps into the inner cavity 11 of the tire main body 1 can be discharged through the drainage and ventilation holes of the tire main body 1 to reduce a self weight of the tire and thereby increase a driving speed of the toy car.

In this embodiment, the tire main body 1 is an elastic tire main body 1, and the filler core 2 is an elastic filler core 2. Through the above structure, the elastic filler core 2 can fill the inner cavity 11 of the tire main body 1, and when the toy car encounters an uneven road surface, the elastic filler core 2 and the elastic tire main body 1 are slightly deformed by the squeezing of the road surface, so that the toy car can smoothly cross the uneven road surface. Moreover, when the toy car crosses the uneven road surface, the elastic filler core 2 and the elastic tire main body 1 can quickly return to their initial shape to support the tire main body 1, so that the toy car can travel more smoothly on the road surface.

Referring to FIGS. 1-8, in some embodiments, the filler core 2 is a sponge filler core 2. Through the above structure, the sponge filler core 2 is not only easy to install and replace, but also has lower production costs, providing strong support to the tire main body 1, so that the tire main body 1 can be prevented from deformation.

Referring to FIGS. 1-8, in some embodiments, the filler core 2 is a silicone filler core 2. Through the above structure, the silicone filler core 2 is not only easy to install and replace, but also provides strong support for the tire main body 1. Moreover, the silicone filler core 2 has a long service life and is not easily damaged. Moreover, when the toy car is driven on rainy days or in water, due to the good hydrophobic performance of the silicone filler core 2, it is not easy to absorb water or store water. The water that seeps into the inner cavity 11 of the tire main body 1 can be more smoothly discharged through the drainage and ventilation holes of the tire main body 1, thereby reducing the self weight of the tire and improving the driving speed of the toy car.

In this embodiment, the filler core 2 is a honeycomb shaped filler core 2. The tire main body 1 is equipped with a first front side wall 14, a first rear side wall 15, and a first circumferential side wall 16 connected to the first front side wall 14 and the first rear side wall 15. The filler core 2 is equipped with a second front side wall 21, a second rear side wall 22, and a second circumferential side wall 23 connected to the second front side wall 21 and the second rear side wall 22. The second circumferential side wall 23 is arranged towards the first circumferential side wall 16, the second front side wall 21 is arranged towards the first front side wall 14, and the second rear side wall 22 is arranged towards the first rear side wall 15. Specifically, the tire main body 1 is equipped with a plurality of drainage and ventilation holes 13. The plurality of drainage and ventilation holes 13 are arranged around the first circumferential side wall 16. Furthermore, a plurality of hollow holes 24 are defined in the filler core 2. The plurality of hollow holes 24 are spaced apart from each other. Furthermore, the hollow hole 24 penetrates from the second front side wall 21 to the second rear side wall 22. The plurality of hollow holes 24 are arranged transversely and longitudinally along the second front side wall 21 and the second rear side wall 22. Through the above structure, when the toy car is driven on rainy days or in water, since the filler core 2 is provided with the plurality of hollow holes 24, and the plurality of hollow holes 24 are spaced apart from each other, the filler core 2 has good hydrophobic performance and is less likely to absorb water or store water. The water that seeps into the inner cavity 11 of the tire main body 1 can be smoothly discharged through the drainage and ventilation holes of the tire main body 1, thereby reducing the self weight of the tire and improving the driving speed of the toy car. Moreover, due to the arrangement of the plurality of hollow holes 24, the elasticity of the filler core 2 can be enhanced. The elastic filler core 2 and the elastic tire main body 1 undergo slight deformation under the squeezing of the road surface, allowing the toy car to smoothly cross the uneven road surface. When the toy car crosses the uneven road surface, the elastic filler core 2 and the elastic tire main body 1 can quickly return to their initial shape, allowing the elastic filler core 2 to support the tire main body 1 and enabling the toy car to travel more smoothly on the road surface. Furthermore, due to the arrangement of the plurality of hollow holes 24, a self weight of the filler core 2 is greatly reduced, thereby reducing the self weight of the tire and improving the driving speed of the toy car. Moreover, due to the arrangement of the plurality of hollow holes 24, a material for producing the filler core 2 can be saved, not only reducing production costs, but also being more environmentally friendly.

In this embodiment, the filler core 2 includes a first hollow area 25 and a second hollow area 26. The first hollow area 25 and the second hollow area 26 are arranged in sequence from a center of the filler core 2 to an edge of the filler core 2. The plurality of hollow holes 24 include a plurality of first hollow hole units 241 and second hollow hole units 242. The plurality of first hollow hole units 241 are arranged along a circumference of the first hollow area 25, and the plurality of second hollow hole units 242 are arranged along a circumference of the second hollow area 26. A shape of the first hollow hole unit 241 is different from a shape of the second hollow hole unit 242. The filler core 2 includes a third hollow area 27. The third hollow area 27 is positioned between the first hollow area 25 and the second hollow area 26. The plurality of hollow holes 24 also include a plurality of third hollow hole units 243. The plurality of third hollow hole units 243 are arranged along a circumference of the third hollow area 27. A shape of the third hollow hole unit 243 is different from the shape of the first hollow hole unit 241 and the shape of the second hollow hole unit 242. Specifically, the plurality of hollow holes 24 also include a plurality of fourth hollow hole units 244. The plurality of fourth hollow hole units 244 are arranged along the circumference of the first hollow area 25. The fourth hollow hole unit 244 and the first hollow hole unit 241 are spaced apart from each other. A shape of the fourth hollow hole unit 244 is different from the shape of the first hollow hole unit 241. Furthermore, the plurality of hollow holes 24 also include a plurality of fifth hollow hole units 245. The plurality of fifth hollow hole units 245 are arranged along the circumference of the second hollow area 26. The fifth hollow hole unit 245 and the second hollow hole unit 242 are spaced apart from each other. A shape of the fifth hollow hole unit 245 is different from the shape of the second hollow hole unit 242. Furthermore, the shape of the fourth hollow hole unit 244 is complementary to the shape of the first hollow hole unit 241. The shape of the fifth hollow hole unit 245 is complementary to the shape of the second hollow hole unit 242. Furthermore, the third hollow hole unit 243 is elliptical in shape. The first hollow hole unit 241 is in a tower shape. The second hollow hole unit 242 is trapezoidal in shape, and the fifth hollow hole unit 245 is triangular in shape. Furthermore, a shape of a first hollow part 41 is triangular, and a shape of a second hollow part 42 is elliptical. Through the above structure, the design is reasonable, effectively achieving the arrangement of the plurality of hollow holes 24. The first hollow hole unit 241 and the fourth hollow hole unit 244 both defined in the first hollow area 25, the second hollow hole unit 242 and the fifth hollow hole unit 245 both defined in the second hollow area 26, and the third hollow hole unit 243 defined in the third hollow area 27, enable the filler core 2 to be fully hydrophobic and drained, avoiding water absorption and water storage in the filler core 2.

In this embodiment, the tire main body 1 is provided with a plurality of protruding anti-slip patterns 17. The plurality of protruding anti-slip patterns 17 are arranged around the tire main body 1. The anti-slip patterns 17 include a plurality of protruding first anti-slip patterns 171, a plurality of protruding second anti-slip patterns 172, a plurality of protruding third anti-slip patterns 173, and a plurality of protruding fourth anti-slip patterns 174. A shape of the first anti-slip pattern 171 is identical with a shape of the second anti-slip pattern 172, a shape of the third anti-slip pattern 173 is identical with a shape of the fourth anti-slip pattern 174, and the shape of the first anti-slip pattern 171 is different from the shape of the third anti-slip pattern 173. The first anti-slip pattern 171 and the second anti-slip pattern 172 are respectively positioned at a front edge and a rear edge of the first circumferential side wall 16. The third anti-slip pattern 173 and the fourth anti-slip pattern 174 are positioned between the first anti-slip pattern 171 and the second anti-slip pattern 172. Moreover, the third anti-slip pattern 173 and the fourth anti-slip pattern 174 are arranged side by side in a middle portion of the first circumferential side wall 16. The plurality of first anti-slip patterns 171, the plurality of second anti-slip patterns 172, the plurality of third anti-slip patterns 173, and the plurality of fourth anti-slip patterns 174 are arranged around the first circumferential side wall 16. The first anti-slip pattern 171 includes a first anti-slip pattern unit 1711 and a second anti-slip pattern unit 1712. The second anti-slip pattern 172 includes a third anti-slip pattern unit 1721 and a fourth anti-slip pattern unit 1722. A shape of the first anti-slip pattern unit 1711 is different from a shape of the second anti-slip pattern unit 1712. A shape of the third anti-slip pattern unit 1721 is different from a shape of the fourth anti-slip pattern unit 1722. The shape of the first anti-slip pattern unit 1711 is identical with the shape of the third anti-slip pattern unit 1721. The shape of the second anti-slip pattern unit 1712 is identical with the shape of the fourth anti-slip pattern unit 1722. The first anti-slip pattern unit 1711 and the second anti-slip pattern unit 1712 are spaced apart from each other. The third anti-slip pattern unit 1721 and the four anti-slip pattern unit 1722 are spaced apart from each other. The third anti-slip pattern 173 includes a fifth anti-slip pattern unit 1731, a sixth anti-slip pattern unit 1732, and a seventh anti-slip pattern unit 1733. The fourth anti-slip pattern 174 includes an eighth anti-slip pattern unit 1741, a ninth anti-slip pattern unit 1742, and a tenth anti-slip pattern unit 1743. Shapes of the fifth anti-slip pattern unit 1731, the sixth anti-slip pattern unit 1732, and the seventh anti-slip pattern unit 1733 are different from each other. Shapes of the eighth anti-slip pattern unit 1741, the ninth anti-slip pattern unit 1742, and the tenth anti-slip pattern unit 1743 are different from each other. The shape of the fifth anti-slip pattern unit 1731 is identical with the shape of the eighth anti-slip pattern unit 1741. The shape of the sixth anti-slip pattern unit 1732 is identical with the shape of the ninth anti-slip pattern unit 1742. The shape of the seventh anti-slip pattern unit 1733 is identical with the shape of the tenth anti-slip pattern unit 1743. The fifth anti-slip pattern unit 1731, the sixth anti-slip pattern unit 1732, and the seventh anti-slip pattern unit 1733 are spaced apart from each other. Moreover, the sixth anti-slip pattern unit 1732 is positioned between the fifth anti-slip pattern unit 1731 and the seventh anti-slip pattern unit 1733. The eighth anti-slip pattern unit 1741, the ninth anti-slip pattern unit 1742, and the tenth anti-slip pattern unit 1743 are spaced apart from each other. Moreover, the ninth anti-slip pattern unit 1742 is positioned between the eighth anti-slip pattern unit 1741 and the tenth anti-slip pattern unit 1743. The fifth anti-slip pattern unit 1731 is connected to the first anti-slip pattern unit 1711 through a first connecting rib 175. The eighth anti-slip pattern unit 1741 is connected to the third anti-slip pattern unit 1721 through a second connecting rib 176. The seventh anti-slip pattern unit 1733 is connected to the second anti-slip pattern unit 1712 through a third connecting rib 177. The tenth anti-slip pattern unit 1743 is connected to the fourth anti-slip pattern unit 1722 through a fourth connecting rib 178. Through the above structure, the arrangement of anti-slip patterns is effectively achieved, and since the shape of the first anti-slip pattern 171 is different from the shape of the third anti-slip pattern 173, a grip force of the tire main body 1 can be improved, allowing the tire main body 1 to adapt to different road surfaces, and allowing the toy car to travel smoothly on different road conditions.

In this embodiment, the toy car tire further includes a wheel hub 3, and the tire main body 1 is also provided with a sleeve opening 18. The wheel hub 3 is inserted into the sleeve opening 18. The wheel hub 3 includes a protruding first clamping wall 31, a protruding second clamping wall 32, and a first connecting wall 33 connected to the first clamping wall 31 and the second clamping wall 32. The first connecting wall 33 is inserted into the sleeve opening 18, and the first clamping wall 31 and the second clamping wall 32 clamp the tire main body 1. The first clamping wall 31 is detachably connected to one end of the first connecting wall 33, and the second clamping wall 32 is detachably connected to an opposite end of the first connecting wall 33. Alternatively, the first clamping wall 31 is detachably connected to one end of the first connecting wall 33, and the second clamping wall 32 is integrally formed with an opposite end of the first connecting wall 33. Specifically, the first clamping wall 31 and the first connecting wall 33 are detachably connected by screws. Through the above structure, the design is reasonable, the connection is stable, and the connection between the wheel hub 3 and the tire main body 1 is effectively achieved, which can facilitate the installation and replacement of the wheel hub 3 by a user.

In this embodiment, the wheel hub 3 further includes a connecting part 34. The connecting part 34 is connected to the second clamping wall 32. The connecting part 34 is provided with a connecting hole 341. The connecting hole 341 is configured for connecting with a wheel axle of the toy car. The connecting hole 341 is hexagonal in shape. Through the above structure, the design is reasonable, the connection is stable, and the arrangement of the connecting hole 341 is effectively achieved, making it easy to install the tire on the wheel axle of the toy car.

In this embodiment, the connecting part 34 is connected to the second clamping wall 32 through a plurality of second connecting walls 4. First hollow parts 41 are provided between the plurality of second connecting walls 4, and second hollow parts 42 are provided on the second connecting walls 4. A shape of the second hollow part 42 is different from a shape of the first hollow part 41. Through the above structure, the connection between the connecting part 34 and the second clamping wall 32 is effectively achieved, and due to the arrangement of the second hollow part 42 and the first hollow part 41, a self weight of the wheel hub 3 is greatly reduced, thereby reducing the self weight of the tire and improving the driving speed of the toy car. Moreover, due to the arrangement of the plurality of hollow holes 24, a material for producing the wheel hub 3 can be saved, not only reducing production costs, but also being more environmentally friendly. A total number of the second connecting walls is two to ten, and two to ten second connecting walls are arranged in a circumferential manner around the connecting part of the wheel hub. Specifically, the total number of the second connecting walls is eight.

In this embodiment, the toy car tire further includes an installation cap 5. The installation cap 5 is arranged towards the connecting hole 341, and the installation cap 5 is detachably connected to the wheel hub 3. The installation cap 5 is detachably connected to the wheel hub 3 through screws. Through the above structure, the installation cap 5 can facilitate the precise connection between the wheel axle of the toy car and the wheel hub 3.

In this embodiment, the filler core is also provided with a through hole 28. The through hole 28 is aligned with the sleeve opening. The first connecting wall of the wheel hub is connected to the tire main body through the sleeve opening and the through hole.

Referring to FIGS. 1-8, a toy car is further provided, including the aforementioned toy car tire. Through the above structure, the toy car tire includes the tire main body 1 and the filler core 2. The tire main body 1 includes the inner cavity 11 and the first opening 12. The inner cavity 11 is surrounded and formed by the side wall of the tire main body 1, and the first opening 12 is in communication with the inner cavity 11. The filler core 2 is inserted into the inner cavity 11 through the first opening 12. The filler core 2 is configured for filling the inner cavity 11. Therefore, the filler core 2 is capable of filling the inner cavity 11 of the tire main body 1 to support the tire main body 1, making the tire main body 1 fuller and less prone to deformation. Moreover, compared with an inflatable tire, since the inner cavity 11 is filled with the filler core 2, the toy car tire is not afraid of being punctured. Even if punctured, the tire main body 1 of the tire is still full and does not affect the travel of the toy car.

The above description only describes embodiments of the present disclosure, and is not intended to limit the present disclosure; various modifications and changes can be made to the present disclosure. Any modifications, equivalent substitutions, and improvements made within the spirit and scope of the present disclosure are intended to be included within the scope of the present disclosure.

What is claimed is:

1. A toy car tire, comprising:
a tire main body, wherein the tire main body comprises an inner cavity and a first opening, the inner cavity is surrounded and formed by a side wall of the tire main body, and the first opening is in communication with the inner cavity; and
a filler core, wherein the filler core is inserted into the inner cavity through the first opening, and the filler core is configured for filling the inner cavity.

2. The toy car tire according to claim 1, wherein the tire main body is provided with drainage and ventilation holes, and the drainage and ventilation holes are in communication with the inner cavity.

3. The toy car tire according to claim 1, wherein the tire main body is an elastic tire main body, and the filler core is an elastic filler core.

4. The toy car tire according to claim 3, wherein the filler core is a sponge filler core.

5. The toy car tire according to claim 3, wherein the filler core is a silicone filler core.

6. The toy car tire according to claim 1, wherein the filler core is a honeycomb shaped filler core.

7. The toy car tire according to claim 1, wherein the tire main body is equipped with a first front side wall, a first rear side wall, and a first circumferential side wall connected to the first front side wall and the first rear side wall; the filler core is equipped with a second front side wall, a second rear side wall, and a second circumferential side wall connected to the second front side wall and the second rear side wall; the second circumferential side wall is arranged towards the first circumferential side wall, the second front side wall is arranged towards the first front side wall, and the second rear side wall is arranged towards the first rear side wall.

8. The toy car tire according to claim 7, wherein the tire main body is equipped with a plurality of drainage and ventilation holes, and the plurality of drainage and ventilation holes are arranged around the first circumferential side wall.

9. The toy car tire according to claim 7, wherein a plurality of hollow holes are defined in the filler core, and the plurality of hollow holes are spaced apart from each other.

10. The toy car tire according to claim 9, wherein the hollow hole penetrates from the second front side wall to the second rear side wall; and the plurality of hollow holes are arranged transversely and longitudinally along the second front side wall and the second rear side wall.

11. The toy car tire according to claim 9, wherein the filler core comprises a first hollow area and a second hollow area, the first hollow area and the second hollow area are arranged in sequence from a center of the filler core to an edge of the filler core, the plurality of hollow holes comprise a plurality of first hollow hole units and second hollow hole units, the plurality of first hollow hole units are arranged along a circumference of the first hollow area, and the plurality of second hollow hole units are arranged along a circumference of the second hollow area, and a shape of the first hollow hole unit is different from a shape of the second hollow hole unit.

12. The toy car tire according to claim 11, wherein the filler core comprises a third hollow area, the third hollow area is positioned between the first hollow area and the second hollow area, the plurality of hollow holes also comprise a plurality of third hollow hole units, the plurality of third hollow hole units are arranged along a circumference of the third hollow area, and a shape of the third hollow hole unit is different from the shape of the first hollow hole unit and the shape of the second hollow hole unit.

13. The toy car tire according to claim 11, wherein the plurality of hollow holes also comprise a plurality of fourth hollow hole units, the plurality of fourth hollow hole units are arranged along the circumference of the first hollow area, the fourth hollow hole unit and the first hollow hole unit are spaced apart from each other, and a shape of the fourth hollow hole unit is different from the shape of the first hollow hole unit.

14. The toy car tire according to claim 11, wherein the plurality of hollow holes also comprise a plurality of fifth hollow hole units, the plurality of fifth hollow hole units are arranged along the circumference of the second hollow area, the fifth hollow hole unit and the second hollow hole unit are spaced apart from each other, and a shape of the fifth hollow hole unit is different from the shape of the second hollow hole unit.

15. The toy car tire according to claim 1, wherein the tire main body is provided with a plurality of protruding anti-slip patterns, and the plurality of protruding anti-slip patterns are arranged around the tire main body; the anti-slip patterns comprise a plurality of protruding first anti-slip patterns, a plurality of protruding second anti-slip patterns, a plurality of protruding third anti-slip patterns, and a plurality of protruding fourth anti-slip patterns; a shape of the first anti-slip pattern is identical with a shape of the second anti-slip pattern, a shape of the third anti-slip pattern is identical with a shape of the fourth anti-slip pattern, and the shape of the first anti-slip pattern is different from the shape of the third anti-slip pattern; the first anti-slip pattern and the second anti-slip pattern are respectively positioned at a front edge and a rear edge of the first circumferential side wall, the third anti-slip pattern and the fourth anti-slip pattern are positioned between the first anti-slip pattern and the second anti-slip pattern, and the third anti-slip pattern and the fourth anti-slip pattern are arranged side by side in a middle portion of the first circumferential side wall; and the plurality of first anti-slip patterns, the plurality of second anti-slip patterns, the plurality of third anti-slip patterns, and the plurality of fourth anti-slip patterns are arranged around the first circumferential side wall.

16. The toy car tire according to claim 15, wherein the first anti-slip pattern comprises a first anti-slip pattern unit and a second anti-slip pattern unit, the second anti-slip pattern comprises a third anti-slip pattern unit and a fourth anti-slip pattern unit, a shape of the first anti-slip pattern unit is different from a shape of the second anti-slip pattern unit, a shape of the third anti-slip pattern unit is different from a shape of the fourth anti-slip pattern unit, the shape of the first anti-slip pattern unit is identical with the shape of the third anti-slip pattern unit, the shape of the second anti-slip pattern unit is identical with the shape of the fourth anti-slip pattern unit, the first anti-slip pattern unit and the second anti-slip pattern unit are spaced apart from each other, and the third anti-slip pattern unit and the four anti-slip pattern unit are spaced apart from each other.

17. The toy car tire according to claim 16, wherein the third anti-slip pattern comprises a fifth anti-slip pattern unit, a sixth anti-slip pattern unit, and a seventh anti-slip pattern unit; the fourth anti-slip pattern comprises an eighth anti-slip pattern unit, a ninth anti-slip pattern unit, and a tenth anti-slip pattern unit; shapes of the fifth anti-slip pattern unit, the sixth anti-slip pattern unit, and the seventh anti-slip pattern unit are different from each other; shapes of the eighth anti-slip pattern unit, the ninth anti-slip pattern unit, and the tenth anti-slip pattern unit are different from each other; the shape of the fifth anti-slip pattern unit is identical with the shape of the eighth anti-slip pattern unit; the shape of the sixth anti-slip pattern unit is identical with the shape of the ninth anti-slip pattern unit; the shape of the seventh anti-slip pattern unit is identical with the shape of the tenth anti-slip pattern unit; the fifth anti-slip pattern unit, the sixth anti-slip pattern unit, and the seventh anti-slip pattern unit are spaced apart from each other; the sixth anti-slip pattern unit is positioned between the fifth anti-slip pattern unit and the seventh anti-slip pattern unit; the eighth anti-slip pattern unit, the ninth anti-slip pattern unit, and the tenth anti-slip pattern unit are spaced apart from each other; the ninth anti-slip pattern unit is positioned between the eighth anti-slip pattern unit and the tenth anti-slip pattern unit; the fifth anti-slip pattern unit is connected to the first anti-slip pattern unit through a first connecting rib; the eighth anti-slip pattern unit is connected to the third anti-slip pattern unit through a second connecting rib; the seventh anti-slip pattern unit is connected to the second anti-slip pattern unit through a third connecting rib; the tenth anti-slip pattern unit is connected to the fourth anti-slip pattern unit through a fourth connecting rib.

18. The toy car tire according to claim 1, wherein the toy car tire further comprises a wheel hub, the tire main body is also provided with a sleeve opening, and the wheel hub is inserted into the sleeve opening; the wheel hub comprises a protruding first clamping wall, a protruding second clamping wall, and a first connecting wall connected to the first clamping wall and the second clamping wall; the first connecting wall is inserted into the sleeve opening, and the first clamping wall and the second clamping wall clamp the tire main body.

19. The toy car tire according to claim 18, wherein the wheel hub further comprises a connecting part, the connecting part is connected to the second clamping wall, the connecting part is provided with a connecting hole, the connecting hole is configured for connecting with a wheel axle of a toy car, the first clamping wall is detachably connected to one end of the first connecting wall, and the second clamping wall is detachably connected to an opposite end of the first connecting wall; alternatively, the first clamping wall is detachably connected to one end of the first connecting wall, and the second clamping wall is integrally formed with an opposite end of the first connecting wall.

20. A toy car, comprising the toy car tire according to claim 1.
